(19) United States
(12) Patent Application Publication
(10) Pub. No.: US 2025/0271463 A1
(43) Pub. Date: Aug. 28, 2025

(54) IMPACT DETERMINATION DEVICE

(71) Applicant: TOYOTA JIDOSHA KABUSHIKI KAISHA, Toyota-shi (JP)

(72) Inventor: Nobukazu UEKI, Toyota-shi (JP)

(73) Assignee: TOYOTA JIDOSHA KABUSHIKI KAISHA, Toyota-shi (JP)

(21) Appl. No.: 19/059,733

(22) Filed: Feb. 21, 2025

(30) Foreign Application Priority Data
Feb. 27, 2024 (JP) 2024-027607

(51) Int. Cl. G01P 15/18; B60R 21/00; B60R 21/0132

(52) U.S. Cl. CPC G01P 15/18; B60R 2021/0023; B60R 21/0132

(57) ABSTRACT

The impact determination device includes an internal sensor including an acceleration sensor that detects an acceleration including components in the front-rear direction and the left-right direction of the host vehicle, an external sensor that detects an object around the host vehicle, a threshold setting unit that sets a threshold for determining an impact caused by an object on the host vehicle, and an impact determination unit that determines an impact when the acceleration of each of the components is equal to or greater than the threshold. The threshold setting unit recognizes an impact form of the object with respect to the host vehicle based on a detection result of the external sensor, and sets a threshold for each component of the acceleration in accordance with the impact form.

### CROSS-REFERENCE TO RELATED APPLICATION

This application claims priority to Japanese Patent Application No. 2024-027607 filed on Feb. 27, 2024, incorporated herein by reference in its entirety.

BACKGROUND

### 1. Technical Field

The present disclosure relates to an impact determination device.

### 2. Description of Related Art

Conventionally, a device has been known that detects an acceleration in a front-rear direction and a left-right direction of a vehicle, and determines a collision form of the vehicle by using a comparison result between the detected acceleration and a determination threshold of a collision form stored beforehand as a two-dimensional map (for example, Japanese Unexamined Patent Application Publication No. 2013-220743 (JP 2013-220743 A)).

### SUMMARY

There is a device that determines an impact or a collision by an object on the vehicle based on a comparison result between a threshold and detection values of a front-rear acceleration in the front-rear direction of the vehicle and a left-right acceleration in the left-right direction of the vehicle. In the device, an examination has been performed to make the relationship between the acceleration and the threshold suitable by taking into consideration a collision form between the vehicle and the object. However, in conventional technology, since the determination itself of the collision form is performed only by comparing the acceleration and the threshold, there is room for improvement from a different viewpoint.

An impact determination device relating to one aspect of the present disclosure includes

an acceleration sensor that detects an acceleration including each component in a front-rear direction and a left-right direction of a vehicle,

an external sensor that detects an object in the periphery of the vehicle,

a threshold setting unit that sets a threshold for determining an impact by the object on the vehicle, and

an impact determination unit that determines the impact when the acceleration for each of the components is equal to or more than the threshold, in which

the threshold setting unit is configured to recognize an impact form of the object on the vehicle based on a detection result of the external sensor, and

set the threshold for each of the components of the acceleration in accordance with the impact form.

In the impact determination device according to one aspect of the present disclosure, an impact form of the object on the vehicle is recognized, by the threshold setting unit, based on a detection result of the external sensor. The threshold is set for each of the components of the acceleration in accordance with the impact form. As a result, the threshold can be set by taking into consideration the impact form based on a detection result of the external sensor. Therefore, an impact by the object on the vehicle can be more suitably determined, compared to when the threshold is set, for example, by taking into consideration the impact form recognized based only on a detection result of the acceleration sensor.

In one aspect, the threshold setting unit may be configured to recognize an offset collision of the object on the vehicle as the impact form, and set the threshold for each of the components of the acceleration in accordance with an offset amount of the offset collision.

In this case, since the threshold is set for each of the components of the acceleration in accordance with an offset amount, the accuracy of determining an impact by the object on the vehicle can be improved.

According to the impact determination device of one aspect of the present disclosure, an impact caused by the object on the vehicle can be more suitably determined, compared to when the threshold is set, for example, by taking into consideration the impact form recognized based only on a detection result of the acceleration sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a vehicle including an impact determination device according to an embodiment;

FIG. 2A is a diagram showing an example of mounting an acceleration sensor;

FIG. 2B is a diagram showing another example of mounting an acceleration sensor;

FIG. 3A is a diagram showing an example of an impact form;

FIG. 3B is a diagram showing another example of an impact form;

FIG. 3C is a diagram showing another example of an impact form;

FIG. 4A is a diagram illustrating an example of a time-series graph of acceleration;

FIG. 4B is a diagram illustrating an example of a trajectory and thresholds of acceleration on a two-dimensional plane corresponding to respective components of acceleration in FIG. 4A;

FIG. 5A is a diagram illustrating an example of a time-series graph of acceleration without phase difference;

FIG. 5B is a diagram illustrating an example of trajectories and thresholds obtained by plotting the acceleration in FIG. 5A on a two-dimensional plane;

FIG. 6A is a diagram illustrating an example of a time-series graph of acceleration having a phase difference;

FIG. 6B is a diagram illustrating an example of trajectories and thresholds obtained by plotting the acceleration in FIG. 6A on a two-dimensional plane;

FIG. 7A illustrates another example of a time series graph of acceleration with phase differences;

FIG. 7B illustrates an example of trajectories and thresholds plotting the acceleration of FIG. 7A on a two-dimensional plane;

FIG. 8A is a flowchart illustrating an example of a process of an impact determination ECU in FIG. 1; and

FIG. 8B is a flowchart illustrating an example of a process of recognizing an impact form and setting thresholds in FIG. 8A.

### DETAILED DESCRIPTION OF EMBODIMENTS

Hereinafter, embodiments of the present disclosure will be described with reference to the drawings.

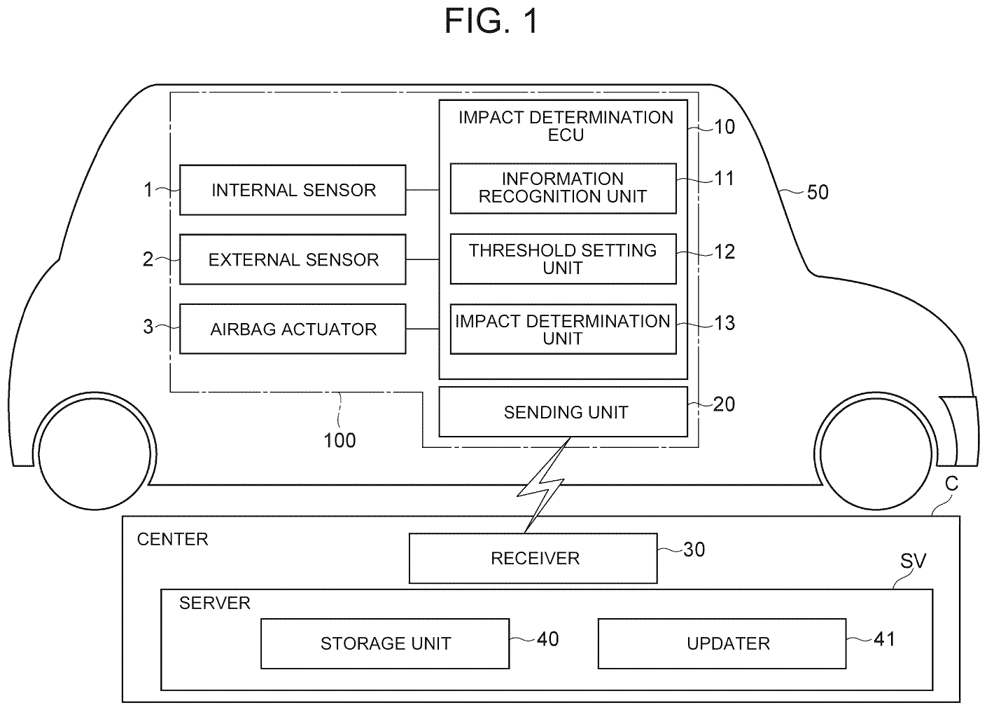

FIG. 1 is a block diagram illustrating a vehicle including an impact determination device according to an embodiment. FIG. 1 shows a host vehicle 50 equipped with an impact determination device 100. The impact determination device 100 is a device for determining an impact caused by an object on the host vehicle 50 by the impact detection using the two-axis acceleration. The host vehicle 50 is, for example, a passenger car or the like. The object is, for example, another vehicle such as a passenger car that travels around the host vehicle 50. The other vehicle is not limited to a passenger car or the like. The object is not limited to another vehicle.

The “impact caused by an object on the host vehicle 50” is, for example, a collision between the host vehicle 50 and an object. The “impact determination” of the present disclosure is not limited to the determination of the presence or absence of a collision. The impact determination device 100 is, for example, a part of a system that activates an airbag when an impact is determined.

As illustrated in FIG. 1, the impact determination device 100 includes an internal sensor 1, an external sensor 2, an airbag actuator 3, and an impact determination ECU (Electronic Control Unit) 10.

The impact determination ECU 10 is an electronic control unit having a CPU (Central Processing Unit) and a storage unit. The storage unit includes, for example, ROM (Read Only Memory), RAM (Random Access Memory), EEPROM (Electrically Erasable Programmable Read-Only Memory), and the like. In the impact determination ECU 10, for example, various functions are realized by executing a program stored in the storage unit by a CPU. The impact determination ECU 10 may include a plurality of electronic units.

The internal sensor 1 is a detection device that detects a traveling state of the host vehicle 50. The internal sensor 1 includes an acceleration sensor. The acceleration sensor is a detector that detects acceleration of the host vehicle 50. The acceleration sensor transmits the detected acceleration data to the impact determination ECU 10. The internal sensor 1 may include a vehicle speed sensor and a yaw rate sensor.

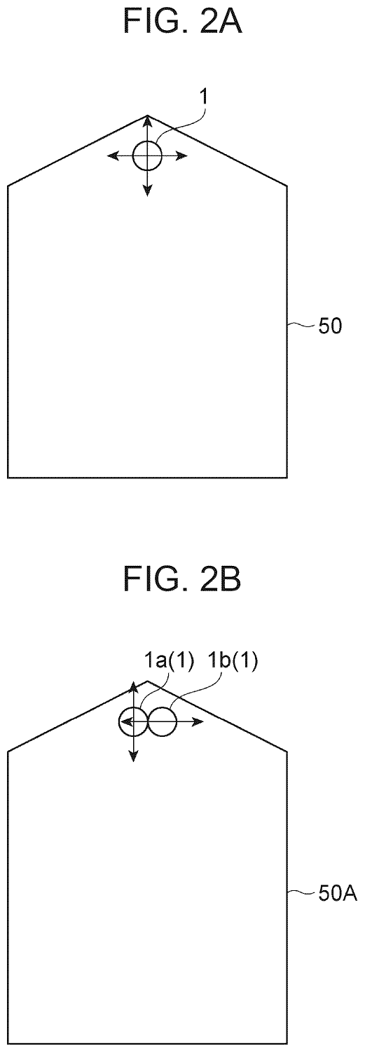

The acceleration sensor of the internal sensor 1 detects acceleration including components in the front-rear direction and the left-right direction of the host vehicle 50. FIG. 2A is diagram illustrating an example of mounting an acceleration sensor. Here, the acceleration sensor incorporates a two-axis sensor in one housing in consideration of, for example, a reduction in the number of sensors, a reduction in the number of harnesses, and an improvement in the degree of freedom of the mounting layout. In the acceleration sensor of the internal sensor 1, for example, the front-rear direction (vehicle traveling direction) of the host vehicle 50 is assigned as the X-axis, and the left-right direction (left-right direction orthogonal to the vehicle traveling direction) of the host vehicle 50 is assigned as the Y-axis. The acceleration sensor of the internal sensor 1 detects the X-axis acceleration in the front-rear direction of the host vehicle 50 and the Y-axis acceleration in the left-right direction of the host vehicle 50.

Note that the acceleration sensor of the internal sensor 1 is not limited to a sensor in which a two-axis sensor is built in one housing. As shown in 50A of the host vehicle in FIG. 2B, a configuration may be adopted in which acceleration sensors 1a, 1b incorporating one-axis sensors in one housing are arranged in the vicinity of each other. The acceleration information of one axis of the acceleration sensors 1a, 1b may be combined and treated as substantially two-axis acceleration information.

The external sensor 2 is a detection device that detects an object around the host vehicle 50. The external sensor 2 includes at least one of a camera and a radar sensor. The camera is an imaging device that captures an image of an external situation of the host vehicle 50. The camera is provided, for example, on the rear side of the windshield of the host vehicle 50 and captures an image of the front of the host vehicle 50. The camera transmits captured images related to the external condition of the host vehicle 50 to the impact determination ECU 10. The radar sensor is a detection device that detects an object around the host vehicle 50 using radio waves (for example, millimeter waves) or light. The radar sensor includes, for example, a millimeter-wave radar or a LiDAR (Light Detection and Ranging). The radar sensor transmits the detected object to the impact determination ECU 10.

The airbag actuator 3 is an actuator for operating an airbag device (not shown). For example, the airbag actuator 3 receives an inflator control signal from the impact determination device 100 under a predetermined condition such as a collision of the host vehicle 50. When receiving the inflator control signal, the airbag actuator 3 operates to deploy the airbag device. The inflator control signal is a signal of a drive instruction to the airbag actuator 3.

Next, a functional configuration of the impact determination ECU 10 will be described. The impact determination ECU 10 includes an information recognition unit 11, a threshold setting unit 12, and an impact determination unit 13.

The information recognition unit 11 recognizes the traveling state of the host vehicle 50 based on the detection result of the internal sensor 1. The traveling state includes an acceleration of the host vehicle 50. The information recognition unit 11 recognizes the acceleration of the two axes of the host vehicle 50 on the basis of the acceleration information of the acceleration sensor. The information recognition unit 11 recognizes the acceleration including the components in the front-rear direction and the left-right direction of the host vehicle 50 based on the detection result of the internal sensor 1.

The information recognition unit 11 recognizes the external environment of the host vehicle 50 based on the detection result of the external sensor 2. The external environment includes a relative position, a relative speed, a moving direction, and the like of a surrounding object with respect to the host vehicle 50. The external environment may include information on types of objects such as other vehicles, pedestrians, and bicycles.

The threshold setting unit 12 sets an acceleration threshold for determining an impact caused by an object on the host vehicle 50. The acceleration threshold is a threshold for each component of acceleration for determining an impact caused by an object on the host vehicle 50. The acceleration threshold includes a threshold for the X-axis acceleration in the front-rear direction of the host vehicle 50 and a threshold for the Y-axis acceleration in the left-right direction of the host vehicle 50.

The threshold setting unit 12 recognizes an impact form of an object with respect to the host vehicle 50 based on a detection result of the external sensor 2. The impact form means a type of force applied to the host vehicle 50 by an object hitting the host vehicle 50 according to a hit direction of the object. The magnitude and orientation of the force may vary depending on the impact form. The force applied to the host vehicle 50 may mean a force at a position where the host vehicle 50 and the object come into contact with each other.

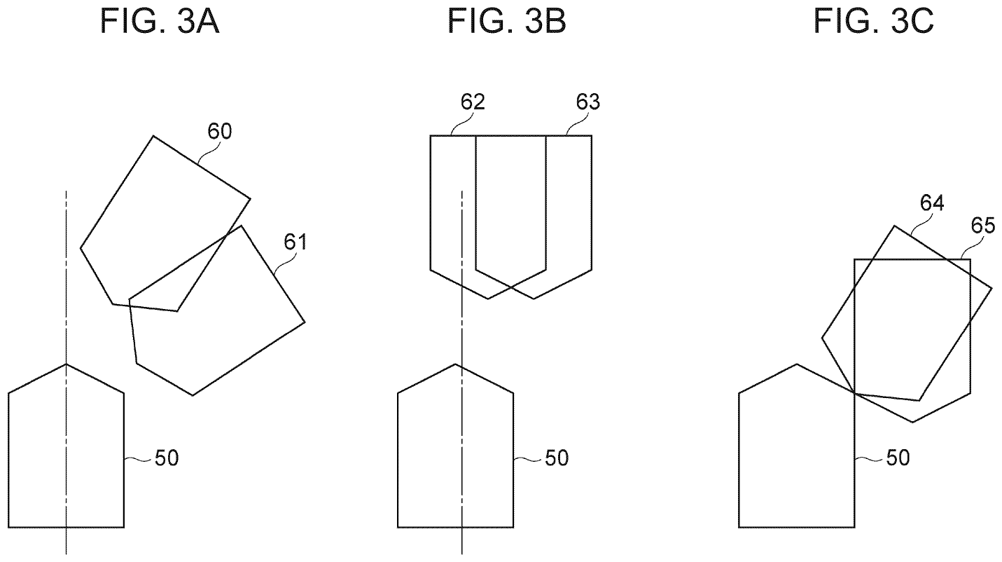

The impact form may be a collision form in which an object (for example, another vehicle, a pole, a wall, or the like) collides with the host vehicle 50. The collision forms include, for example, a head-on collision, a bevel collision, an offset collision, and the like. The front collision is a form in which an object collides with the front surface of the host vehicle 50 so as to face the traveling direction. The frontal collision includes a frontal collision. As shown in FIG. 3A, when the angle formed by the traveling direction of the other vehicle 60 with respect to the traveling direction of the host vehicle 50 is less than a predetermined value, the collision form may be a normal collision. As shown in FIG. 3B, when the shift amount (offset amount) in the left-right direction of the other vehicle 62 with respect to the traveling direction of the host vehicle 50 is less than the predetermined value, the collision form may be a normal collision. The offset amount may be, for example, a shift amount in the left-right direction of the center line in the front-rear direction of the other vehicle 62 with respect to the center line in the front-rear direction of the host vehicle 50.

The oblique collision is a form in which the traveling direction of the object collides with the traveling direction of the host vehicle 50 such that the traveling direction of the object has an angle equal to or greater than a predetermined value. As shown in FIG. 3A, when the angle formed by the traveling direction of the other vehicle 61 with respect to the traveling direction of the host vehicle 50 is equal to or greater than a predetermined value, the collision form may be oblique.

The offset collision is a form in which an object collides with the traveling direction of the host vehicle 50 so as to be displaced in the left-right direction. As illustrated in FIG. 3B, when the offset amount of the other vehicle 63 is equal to or greater than a predetermined value with respect to the traveling direction of the host vehicle 50, the collision form may be an offset collision.

Note that, as shown in FIG. 3C, even when the other vehicles 64 and 65 collide with the host vehicle 50 at the same position, the collision form may differ. For example, if the offset amount of the other vehicle 64 is less than the predetermined value, the collision form in which the other vehicle 64 collides with the host vehicle 50 may be oblique. When the offset amount of the other vehicle 65 is equal to or greater than the predetermined value, the collision form in which the other vehicle 65 collides with the host vehicle 50 may be an offset collision.

The threshold setting unit 12 sets the acceleration threshold for each component of the acceleration according to the impact form. The acceleration threshold can be set in advance by performing a simulation, a collision test, or the like in accordance with a form in which a force applied to the host vehicle 50 by the object hitting the host vehicle 50 propagates along the vehicle body of the host vehicle 50 to the internal sensor 1, and by adaptation.

The impact determination unit 13 determines an impact when the acceleration of each of the components of the acceleration is equal to or greater than the acceleration threshold. For example, the impact determination unit 13 compares the recognized acceleration of the host vehicle 50 with the set acceleration threshold for each component.

The impact determination unit 13 compares, for example, a component of the recognized acceleration in the front-rear direction with a component of the set acceleration threshold in the front-rear direction. The impact determination unit 13 compares the component of the recognized acceleration in the left-right direction with the component of the set acceleration threshold in the left-right direction. The impact determination unit 13 determines the impact when the acceleration is equal to or greater than the acceleration threshold for both the front-rear direction and the left-right direction component. The impact determination unit 13 does not determine the impact when the acceleration is less than the acceleration threshold for any of the components in the front-rear direction and the left-right direction.

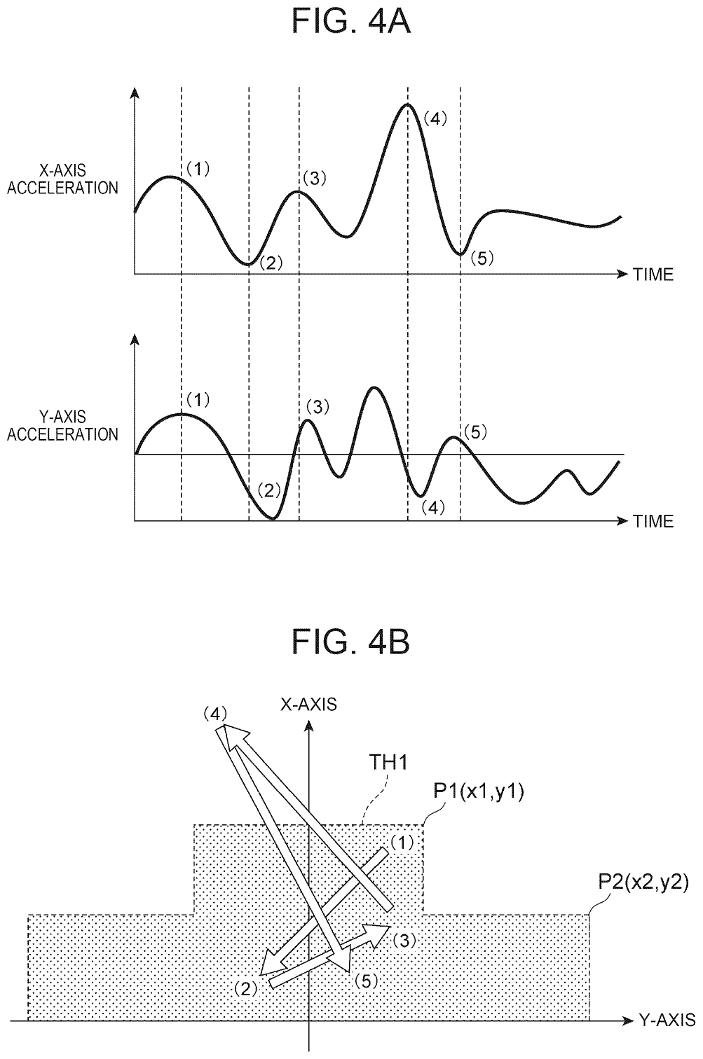

The setting of the acceleration threshold by the threshold setting unit 12 will be described in more detail. FIG. 4A is a diagram illustrating an example of an acceleration-time-series graph. FIG. 4A exemplifies the X-axis acceleration and the Y-axis acceleration corresponding to the force when the force applied to the host vehicle 50 by the object hitting the host vehicle 50 propagates along the vehicle body of the host vehicle 50 to the acceleration sensor.

In the illustrated FIG. 4A, a broken line (1) to a broken line (5) are attached to a part of the maximum value and the minimum value of the X-axis acceleration. The broken line (1) to the broken line (5) may deviate from the positions of the maximum and minimum values of the Y-axis acceleration in the curve of the Y-axis acceleration. That is, the waveform of the X-axis acceleration and the waveform of the Y-axis acceleration may have a phase difference. This phase difference may occur differently depending on, for example, a difference in the structure of the vehicle body (platform) of the host vehicle 50, a difference in the equipment of the host vehicle 50, an installation position of the acceleration sensor (a deviation from the center of the vehicle in the left-right direction, and the like), a collision form, and the like. The structure of the vehicle body of the host vehicle 50 may differ depending on the vehicle case of the host vehicle 50, the destination of the host vehicle 50, and the like. As described above, the propagation path of the impact force applied to the host vehicle 50 propagating to the acceleration sensor can be very complicated. In addition, not only the phase difference but also the X-axis acceleration and the Y-axis acceleration detected by the acceleration sensor may differ in the magnitude of the corresponding peak between the waveforms.

In consideration of the phase difference and the difference in the magnitude of the peak, the threshold setting unit 12 sets an acceleration threshold. FIG. 4B is a diagram illustrating an example of an acceleration trajectory and thresholds on a two-dimensional plane corresponding to the respective components of the acceleration in FIG. 4A.

For convenience of explanation, on the two-dimensional plane In FIG. 4B, the acceleration-thresholds define hatched regions. In the example of FIG. 4B, the hatched region is a convex (inverted T-shaped) region symmetrical to the X-axis on a two-dimensional plane by using coordinates (x1, y1) and (x2, y2) of the points P1, P2 as acceleration thresholds. The acceleration threshold in FIG. 4B is a normal threshold TH1. The normal threshold TH1 is, for example, an acceleration threshold used when a forward collision of another vehicle with respect to the host vehicle 50 is recognized as an impact form. Alternatively, the normal threshold TH1 is, for example, an acceleration threshold used when the possibility of collision between the host vehicle 50 and the object is estimated by a known method based on the detection result of the external sensor 2.

When the position obtained by plotting the X-axis acceleration and the Y-axis acceleration on the two-dimensional plane of FIG. 4B is outside the hatched area, it corresponds to a case where the acceleration is equal to or higher than the acceleration threshold for both the front-rear direction and the left-right direction, and an impact is determined. When the position obtained by plotting the X-axis acceleration and the Y-axis acceleration is present in the hatched region, it corresponds to a case where the acceleration is less than the acceleration threshold for any of the components in the front-rear direction and the left-right direction, and an impact is not determined.

In the host vehicle 50, since the airbag is operated when the impact is determined, the acceleration threshold is set so that the impact is not erroneously determined. Depending on the impact, the hatched area of FIG. 4B is defined such that the position where the X-axis acceleration and the Y-axis acceleration are plotted is within the hatched area. The impact is, for example, an impact caused by vibration during normal acceleration/deceleration and steering of the host vehicle 50, an input from the uneven road surface, a slight collision with an object, or the like. Incidentally, in view of the reduction in the computational loads of the impact determination ECU 10, the acceleration thresholds may be set so as to define hatched regions in which the outer edges are linear.

Incidentally, in FIG. 4B, the position (1) to the position (5) are shown along the locus of the white arrow. The position (1) to the position (5) in FIG. 4B correspond to the positions obtained by plotting the X-axis acceleration and the Y-axis acceleration on the two-dimensional plane at the time of the broken line (1) to the broken line (5) in FIG. 4A. When there is a phase difference as shown in FIG. 4A between the waveform of the X-axis acceleration and the waveform of the Y-axis acceleration, the position where the X-axis acceleration and the Y-axis acceleration are plotted, such as the trajectory of the white arrow in FIG. 4B, may move in a complicated manner on a two-dimensional plane.

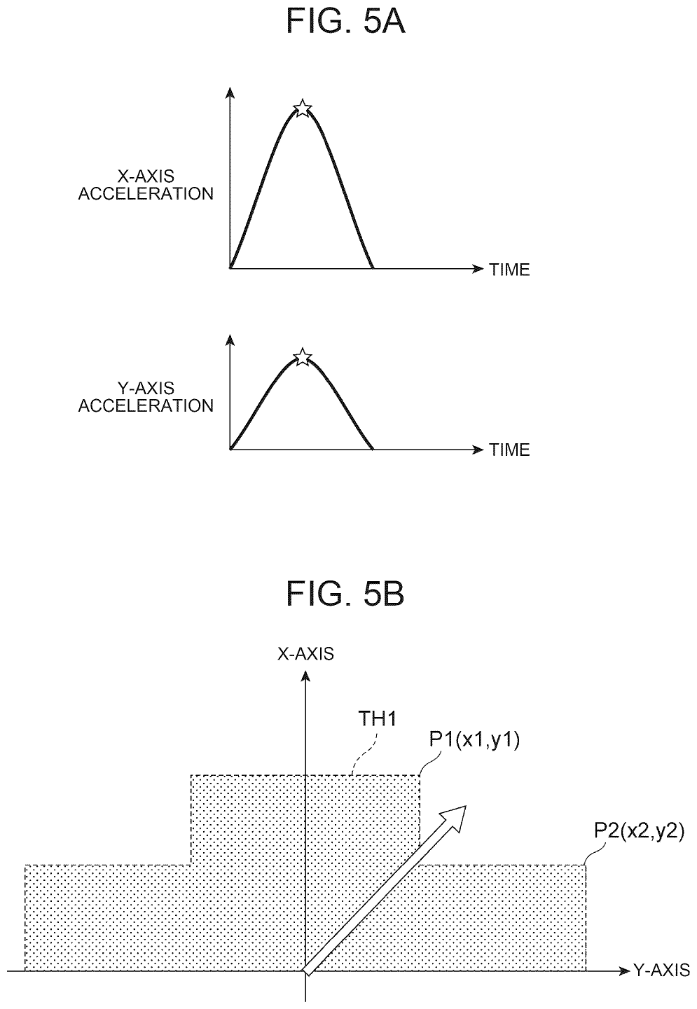

FIG. 5A is a diagram showing a time series chart of accelerations without phase differences. FIG. 5B shows the trajectories and thresholds plotted on a two-dimensional plane of the accelerations in the FIG. 5A. As shown in FIG. 5A, for example, as in the case where the impact form is a normal collision, the phase difference between the waveform of the X-axis acceleration and the waveform of the Y-axis acceleration (the difference in the time of the peak indicated by the asterisk in the drawing) may be within a predetermined time difference (substantially simultaneously). In this case, as shown in FIG. 5B, the position where the X-axis acceleration and the Y-axis acceleration are plotted (the leading edge of the white arrow) exists outside the hatched area defined by the normal threshold TH1, and an impact can be determined appropriately. The hatched area defined by the normal threshold TH1 may be defined by a plurality of straight lines that are substantially perpendicular to the X-axis or the Y-axis on a two-dimensional plane.

However, due to the difference between the phase difference between the waveform of the X-axis acceleration and the waveform of the Y-axis acceleration and the difference between the magnitudes of the peaks, the position at which the X-axis acceleration and the Y-axis acceleration are plotted may not be appropriately outside the hatched area as illustrated in FIG. 5A and FIG. 5B. In this case, there is a possibility that an impact cannot be erroneously determined.

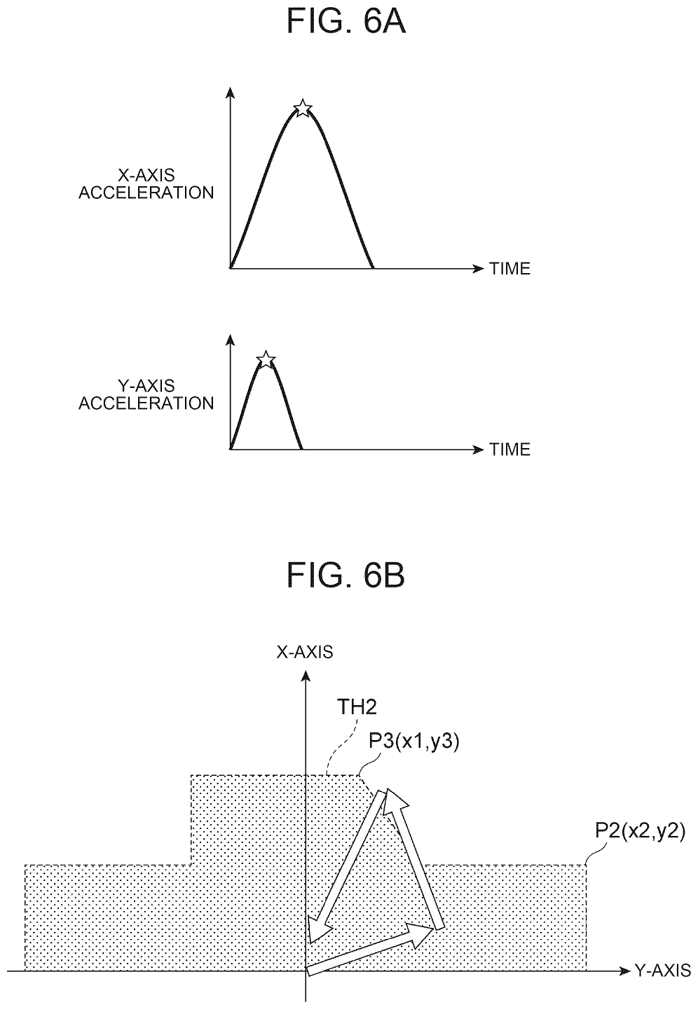

FIG. 6A is a diagram showing a time series chart of accelerations with phase differences. FIG. 6B shows an example of the trajectories and thresholds obtained by plotting the accelerations in FIG. 6A on a two-dimensional plane. For example, if the impact form is a bevel, or if the impact form is a bevel and an offset collision, it can be an acceleration wave form as shown in FIG. 6A. As described above, when the phase difference such that the peak of the waveform of the Y-axis acceleration becomes earlier than the waveform of the X-axis acceleration exceeds the predetermined time difference, the acceleration threshold may be set as the first corrected threshold TH2 using the coordinates (x1, y3) of the point P3. Here, the hatched area defined by the first corrected threshold TH2 includes a part defined by an inclined straight line with respect to the X-axis and the Y-axis on the two-dimensional plane.

The acceleration-threshold may be set to include a y3 of coordinates. y3 is less absolute than y1. The value of the coordinate y3 may be set by, for example, determining the slope of the slope line from the difference between the phase difference between the waveform of the X-axis acceleration and the waveform of the Y-axis acceleration and the difference between the magnitudes of the peaks on the basis of the simulation when the impact form is oblique collision or the collision test result. The slope line may include a plurality of fold points or may be set asymmetrically with respect to the X-axis.

As a result, as shown in FIG. 6B, the position where the X-axis acceleration and the Y-axis acceleration are plotted (the leading edge of the white arrow) exists outside the hatched area defined by the first corrected threshold TH2, and an impact can be appropriately determined.

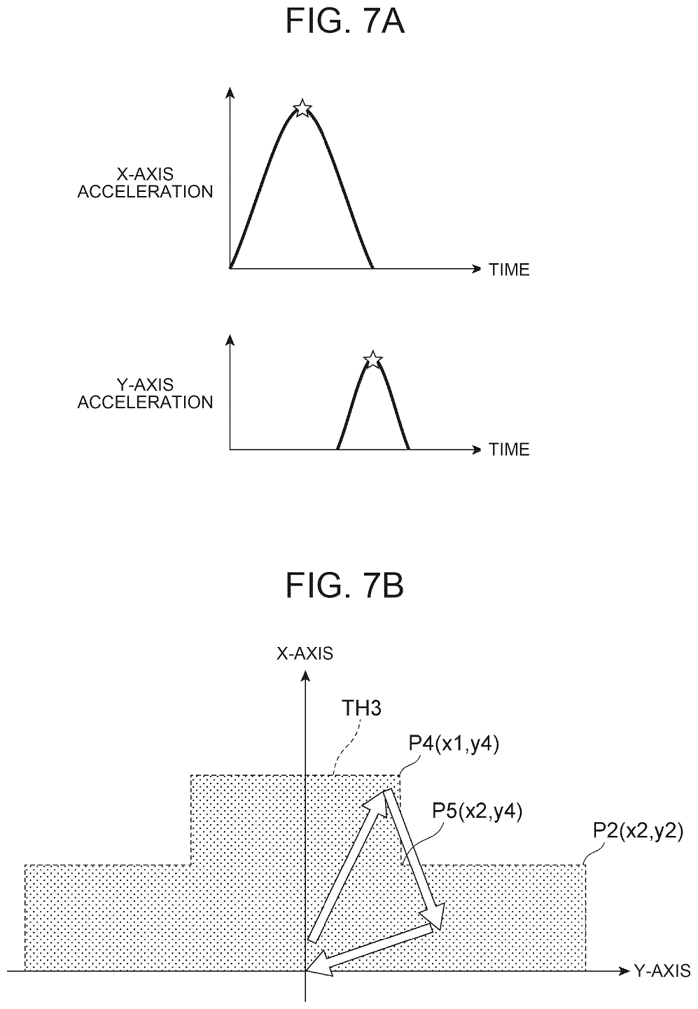

The threshold setting unit 12 may recognize an offset collision of another vehicle with respect to the host vehicle 50 as an impact form, and may set an acceleration threshold for each component of acceleration in accordance with an offset amount of the offset collision. FIG. 7A is a diagram showing another example of a time series graph of accelerations with phase differences. FIG. 7B shows the trajectories and thresholds plotted on a two-dimensional plane of the accelerations in the FIG. 7A. For example, when the impact form is an offset collision having a large offset amount, or an offset collision not being an oblique collision, the impact form may be an acceleration wave form as shown in FIG. 7A. As described above, there may be a case where the phase difference such that the peak of the waveform of the X-axis acceleration becomes earlier than that of the waveform of the Y-axis acceleration exceeds a predetermined time difference. In this case, the acceleration threshold may be a second corrected threshold TH3 using coordinates (x1, y4) and (x2, y4) of the points P4, P5. Here, the hatched area defined by the second corrected threshold TH3 may not include a part defined by an inclined straight line with respect to the X-axis and the Y-axis on the two-dimensional plane.

The acceleration-threshold may be set to include a y4 of coordinates. y4 is less absolute than y1. y4 may be larger in absolute magnitude than y3. The value of the coordinate y4 may be set by, for example, determining the difference between y1 and the difference between the phase difference between the waveform of the X-axis acceleration and the waveform of the Y-axis acceleration and the magnitude of the peak based on the simulation or the collision test result when the impact form is the offset collision.

As a result, as shown in 7B, the trajectory (white arrow) at the position where the X-axis acceleration and the Y-axis acceleration are plotted passes outside the hatched area defined by the second corrected threshold TH3, and an impact can be determined appropriately.

Incidentally, the acceleration thresholds may be updated by an updating process from a server SV provided in the center C. The transmission unit 20 of the impact determination device 100 and the reception unit 30 of the center C are configured to be able to communicate with each other by known wireless communication. SV of servers may be a common computer. The storage unit 40 of the server SV stores, for example, information for updating acceleration thresholds based on such knowledge when knowledge that can further improve security is obtained. The updating unit 41 can update the acceleration threshold of the host vehicle 50 using the update information of the storage unit 40. However, the term “update” as used herein means an update within a range in which the preset acceleration threshold of the host vehicle 50 satisfies the authentication test such as collision safety at the time of initial sales, and the authentication test result is not damaged at all even if the acceleration threshold is updated, and the safety is improved.

### Operation of Impact Determination Device

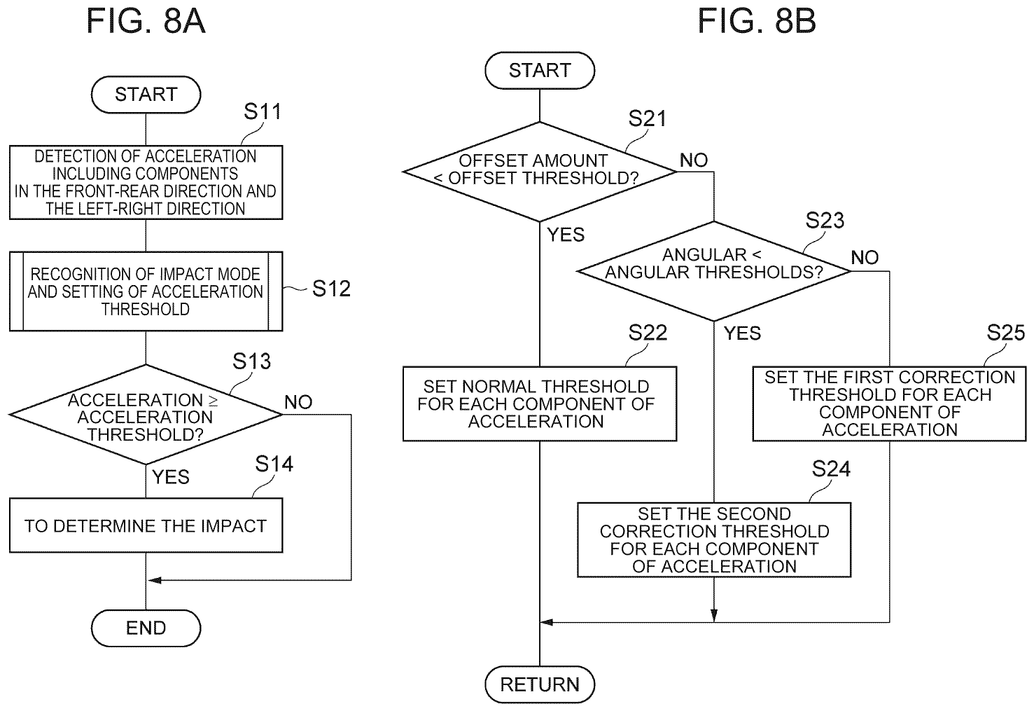

Next, the operation of the impact determination device 100 will be described with reference to the drawings. FIG. 8A is a flowchart illustrating an example of a process of an impact determination ECU in FIG. 1. FIG. 8B is a flow chart illustrating an exemplary process of recognizing an impact form and setting thresholds in FIG. 8A. The processes of FIG. 8A and FIG. 8B may be executed when the vehicle speed of the host vehicle is equal to or higher than a predetermined vehicle speed threshold.

As shown in FIG. 8A, the impact determination ECU 10 of the impact determination device 100 recognizes, as S11, accelerations including the components in the front-rear direction and the left-right direction by the information recognition unit 11. The information recognition unit 11 recognizes the acceleration including the components in the front-rear direction and the left-right direction of the host vehicle 50 based on the detection result of the internal sensor 1.

In S12, the impact determination ECU 10 recognizes an impact form and sets an acceleration threshold by the threshold setting unit 12. The threshold setting unit 12 recognizes an impact form of the other vehicle with respect to the host vehicle 50 based on a detection result of the external sensor 2. The threshold setting unit 12 sets an acceleration threshold for each component of the recognized acceleration according to an impact form.

The threshold setting unit 12 sets an acceleration threshold in the front-rear direction in accordance with an impact form with respect to a component of the recognized acceleration in the front-rear direction. The threshold setting unit 12 sets an acceleration threshold in the left-right direction in accordance with an impact form with respect to a component of the recognized acceleration in the left-right direction. The impact determination ECU 10 may perform, for example, a process of FIG. 8B as a specific process of S12.

As illustrated in FIG. 8B, in S21, the impact determination ECU 10 determines whether the offset amount is less than the offset threshold by the threshold setting unit 12. For example, the threshold setting unit 12 recognizes the offset amount of the other vehicle with respect to the host vehicle 50 based on the detection result of the external sensor 2, and compares the offset amount with the offset threshold. In a case where the offset amount is less than the offset threshold, the threshold setting unit 12 may recognize, as an impact form, the forward collision of the other vehicle with respect to the host vehicle 50. When the offset amount is equal to or larger than the offset threshold, the threshold setting unit 12 may recognize an offset collision of another vehicle with respect to the host vehicle 50 as an impact form.

When it is determined that the offset amount is less than the offset threshold (S21: YES), in S22, the impact determination ECU 10 sets the normal threshold for each component of the acceleration by the threshold setting unit 12. The threshold setting unit 12 reads out x1, y1, x2, y2 or the like for each component of the acceleration, plots P1, P2 on a two-dimensional plane, and sets the normal threshold TH1 passing through P1, P2 as the acceleration threshold, for example, as shown in FIG. 4A to FIG. 4B, and FIG. 5A to FIG. 5B. Note that the threshold setting unit 12 may be estimated by a known method that the offset amount is less than the offset threshold and the possibility of collision between the host vehicle 50 and the object is low based on the detection result of the external sensor 2.

In this case, the normal threshold TH1 may be set as the acceleration threshold without specifically recognizing the impact form. After that, the impact determination ECU 10 ends the process of the current FIG. 8B and returns to the process of S13 of FIG. 8A.

When it is determined that the offset amount is equal to or larger than the offset threshold (S21: NO), in S23, the impact determination ECU 10 determines whether or not the angle is less than the angle threshold by the threshold setting unit 12. The threshold setting unit 12 recognizes the angle of the other vehicle with respect to the host vehicle 50 based on the detection result of the external sensor 2, and compares the angle with the angle threshold. When the angle is less than the angle threshold, the threshold setting unit 12 may recognize an offset collision that is not an oblique collision as an impact form. When the angle amount is equal to or larger than the angle threshold, the threshold setting unit 12 may recognize an oblique collision and an offset collision as an impact form.

If it is determined that the angle is less than the angle threshold (S23: YES), in S24, the impact determination ECU 10 sets the second correction threshold for each component of the acceleration by the threshold setting unit 12. For example, as shown in FIG. 7A and FIG. 7B, the threshold setting unit 12 may read x1, y4, x2, y4 or the like for each component of the acceleration, plot P2, P4, P5 on a two-dimensional plane, and set the second corrected threshold TH3 passing through P2, P4, P5 as the acceleration threshold. After that, the impact determination ECU 10 ends the process of the current FIG. 8B and returns to the process of S13 of FIG. 8A.

When it is determined that the angle is equal to or larger than the angle threshold (S23: NO), in S25, the impact determination ECU 10 sets the first correction threshold for each component of the acceleration by the threshold setting unit 12. For example, as shown in FIG. 6A and FIG. 6B, the threshold setting unit 12 may read x1, y3, x2, y2 or the like for each component of the acceleration, plot P2, P3 on a two-dimensional plane, and set the first corrected threshold TH2 passing through P2, P3 as the acceleration threshold. After that, the impact determination ECU 10 ends the process of the current FIG. 8B and returns to the process of S13 of FIG. 8A.

Returning to FIG. 8A, in S13, the impact determination ECU 10 determines whether the acceleration is equal to or greater than the acceleration threshold by the impact determination unit 13. For example, the impact determination unit 13 compares the recognized acceleration of the host vehicle 50 with the acceleration thresholds set by S12. The impact determination unit 13 compares the component of the recognized acceleration in the front-rear direction with the component of the set acceleration threshold in the front-rear direction. The impact determination unit 13 compares the component of the recognized acceleration in the left-right direction with the component of the set acceleration threshold in the left-right direction. The impact determination unit 13 determines that S13 process is “YES” when the acceleration is equal to or greater than the acceleration threshold for both the front-rear direction and the left-right direction components. When the acceleration is less than the acceleration threshold for any of the components in the front-rear direction and the left-right direction, the impact determination unit 13 determines that S13 process is “NO”.

In S14, the impact determination ECU 10 determines the impact by the impact determination unit 13. In S14, the impact determination unit 13 determines an impact on the host vehicle 50 on the assumption that there is an impact of a certain level or more by the other vehicle. The impact determination ECU 10 may transmit an inflator control signal for deploying the airbag device to the airbag actuator 3. Thereafter, the impact determination ECU 10 ends the process of the present FIG. 8A.

In the impact determination device 100 described above, in the impact determination ECU 10, the threshold setting unit 12 recognizes the impact form of the other vehicle with respect to the host vehicle 50 on the basis of the detection result of the external sensor 2. The acceleration threshold is set for each component of the acceleration according to the impact form. Accordingly, the acceleration threshold can be set in consideration of the impact form based on the detection result of the external sensor 2. Therefore, it is possible to more appropriately determine the impact of the other vehicle on the host vehicle 50 as compared with, for example, a case where the acceleration threshold is set in consideration of the impact form recognized only based on the detection result of the acceleration sensor. As a result, it is possible to realize a system using an impact determination result at low cost while minimizing a decrease in detection performance.

In the impact determination device 100, the threshold setting unit 12 recognizes the offset collision of the other vehicle with respect to the host vehicle 50 as the impact form, and sets the acceleration threshold for each component of the acceleration in accordance with the offset amount of the offset collision. Accordingly, since the acceleration threshold is set for each component of the acceleration in accordance with the offset amount, it is possible to improve the accuracy of determining the impact of the other vehicle on the host vehicle 50.

Although the embodiments of the present disclosure have been described above, the present disclosure is not limited to the above-described embodiments. The present disclosure may be embodied in various forms with various changes and modifications, including the above-described embodiments, based on the knowledge of those skilled in the art.

In the above-described embodiment, the threshold setting unit 12 sets the acceleration threshold for each component of the acceleration in accordance with the offset amount of the offset collision and the angle of the other vehicle with respect to the host vehicle 50, but the present disclosure is not limited to this example. For example, the threshold setting unit 12 may set the acceleration threshold for each component of the acceleration in accordance with information such as the vehicle type of the other vehicle (that is, the size and the weight of the other vehicle), the relative speed of the other vehicle with respect to the host vehicle 50, and the speed of the host vehicle 50.

In the above-described embodiment, the acceleration threshold is set for each component of the acceleration according to the offset amount of the offset collision, but this example may be omitted.

In the above-described embodiment, an example in which the airbag device is deployed as a system using an impact determination result has been described, but this example is not essential. The impact determination device 100 only needs to be able to determine at least the impact.

What is claimed is:

1. An impact determination device comprising:
an acceleration sensor that detects an acceleration including each component in a front-rear direction and a left-right direction of a vehicle;
an external sensor that detects an object in a periphery of the vehicle;
a threshold setting unit that sets a threshold for determining an impact by the object on the vehicle; and
an impact determination unit that determines the impact when the acceleration for each of the components is equal to or more than the threshold, wherein the threshold setting unit is configured to
recognize an impact form of the object on the vehicle based on a detection result of the external sensor, and
set the threshold for each of the components of the acceleration in accordance with the impact form.

2. The impact determination device according to claim 1, wherein the threshold setting unit is configured to
recognize an offset collision of the object on the vehicle as the impact form, and
set the threshold for each of the components of the acceleration in accordance with an offset amount of the offset collision.
